(19) United States
(12) Patent Application Publication
(10) Pub. No.: US 2016/0272290 A1
(43) Pub. Date: Sep. 22, 2016

(54) UNDERWATER VEHICLE FOR TRANSPORTING FLUIDS SUCH AS FOR EXAMPLE NATURAL GAS, OIL OR WATER, AND PROCESS FOR USING SAID VEHICLE

(71) Applicant: ENI S.P.A., Roma (IT)

(72) Inventors: Stefano CARMINATI, Monza (MB) (IT); Alessio NISTA, Spinea (VE) (IT)

(73) Assignee: ENI S.p.A., Roma (IT)

(21) Appl. No.: 15/030,274

(22) PCT Filed: Oct. 20, 2014
(86) PCT No.: PCT/IB2014/065464

§ 371 Date: Apr. 18, 2016

(30) Foreign Application Priority Data
Oct. 21, 2013 (IT) MI2013A 001754

(51) Int. Cl. B63G 8/00; B63B 13/00; B63B 21/50; B63B 21/56; E21B 41/04; F25J 3/08; E21B 43/40; B01D 53/22; B01D 46/24; B01D 53/047; C10G 7/00; B63B 25/12; E21B 43/01

(52) U.S. Cl. CPC B63G 8/001; B63B 25/12; B63B 13/00; B63B 21/50; B63B 21/56; E21B 41/04; E21B 43/01; E21B 43/40; B01D 53/22; B01D 46/2403; B01D 53/047; C10G 7/00; F25J 3/08; B63B 2025/085

(57) ABSTRACT

An underwater vehicle for transporting extraction fluids, for example natural gas, oil or water, has an overall elongated form and includes one or more containment tubes configured to contain the fluid to be transported and forming a bundle that prevalently extends longitudinally with respect to the underwater vehicle, making the vehicle structurally more robust and intrinsically safe.

### FIELD OF THE INVENTION

The present invention relates to an underwater vehicle for transporting fluids such as, for example, natural gas, oil or water, and a process for using said vehicle.

### STATE OF THE ART

Tanks designated to remain completely submerged while they are being towed by a vessel for transporting natural gas or oil, as an alternative to fixed pipes lying on seabeds or ocean-beds or to tankers, are known. Examples of this transportation procedure are described in the documents US 2011/0000546, U.S. Pat. No. 3,975,167 and U.S. Pat. No. 6,260,501.

The document US 2011/0000546 describes a first example of an underwater tank comprising a steel cage containing a flexible bag, destined for containing the gas or oil to be transported. According to the authors of the present invention, this type of tank does not have a particular structural robustness; furthermore the considerable variability of the form and volume of the flexible bag in relation to the filling degree increases the fluid-dynamic resistance to advancement and makes it more difficult to balance the load and distribute it as desired.

The document U.S. Pat. No. 3,975,167 describes a second example of underwater tank which allows natural gas to be transported in the form of hydrates also called clathrates. The transformation of natural gas to hydrates and the reverse transformation when the tank is discharged, increase the transportation costs; furthermore, hydrates have a much greater specific weight with respect to compressed or liquefied natural gas, and in any case greater than oil, and this makes the floating of the tank more difficult; finally, it seems that no-one has so far succeeded in developing an economically convenient procedure for storing and transporting gas through hydrates.

The document U.S. Pat. No. 6,260,501 describes a third example of an underwater tank for transporting compressed gas, storing it in coil- or ring-wound pipes. The mechanical structure of this third variant is, according to the authors of the present invention, relatively complex and costly to construct, and also relatively heavy and not mechanically robust.

It would also be desirable to be able to avail of transporting systems alternative to the known systems, to be able to exploit reservoirs with wellheads situated on seabeds or ocean-beds at great depths, or underwater wells having a capacity which is not sufficiently high as to make convenient the laying of oil-pipelines or gas-pipelines fixed on seabeds, the installation of a fixed extraction platform or the permanent immobilization of extraction and pretreatment vessels such as, for example, so-called floating production, storage and offloading units (FPSO). Using, for this purpose, tanks which are completely submerged for transporting natural gas or oil from the well to the oil-pipeline, gas-pipeline or closest treatment plant on the mainland, would be desirable for various reasons, for example the lower risk of collision with other vessels, a greater intrinsic safety against fires, explosions and leakages of gas or other fluids transported, a greater intrinsic safety for the crew, which would operate at a greater distance from the material transported, which is often flammable. The authors of the present invention, however, believe that the known underwater tanks previously described do not allow a sufficiently economical or safe transportation.

An objective of the present invention is to overcome the drawbacks of the state of the art mentioned above, and in particular, to provide a system for transporting fluids such as, for example, natural gas, oil or water which is more efficient and less expensive than the known underwater tanks.

### SUMMARY OF THE INVENTION

This objective is achieved, in a first aspect of the present invention, with an underwater vehicle having the characteristics according to claim 1.

In a second aspect of the invention, this objective is achieved with a procedure having the characteristics according to claim 11.

In a third aspect of the invention, this objective is achieved with a procedure having the characteristics according to claim 12.

Further characteristics of the device are object of the dependent claims.

The advantages that can be obtained with the present invention will appear more evident to a skilled person in the field from the following detailed description of a particular non-limiting embodiment example, illustrated with reference to the following schematic figures.

### LIST OF FIGURES

FIG. 1 shows a first side view of an underwater vehicle towed by two tugs during normal navigation, according to a particular embodiment of the invention;

FIG. 2 shows a first perspective view of the underwater vehicle of FIG. 1;

FIG. 3 shows a second partially exploded perspective view of the underwater vehicle of FIG. 1, without the covering shell and with the removable module extracted from the body of the underwater vehicle;

FIG. 4 shows a second perspective view of the underwater vehicle of FIG. 1, without the covering shell and partially sectioned according to a longitudinal and vertical plane;

FIG. 5 shows the perspective view of a transverse rib of the underwater vehicle of FIG. 1;

FIG. 6 shows a perspective view with a detail of the stern of the underwater vehicle of FIG. 1, without the covering shell;

FIG. 7 shows a second side view of the underwater vehicle of FIG. 1 in an emergency condition.

### DETAILED DESCRIPTION

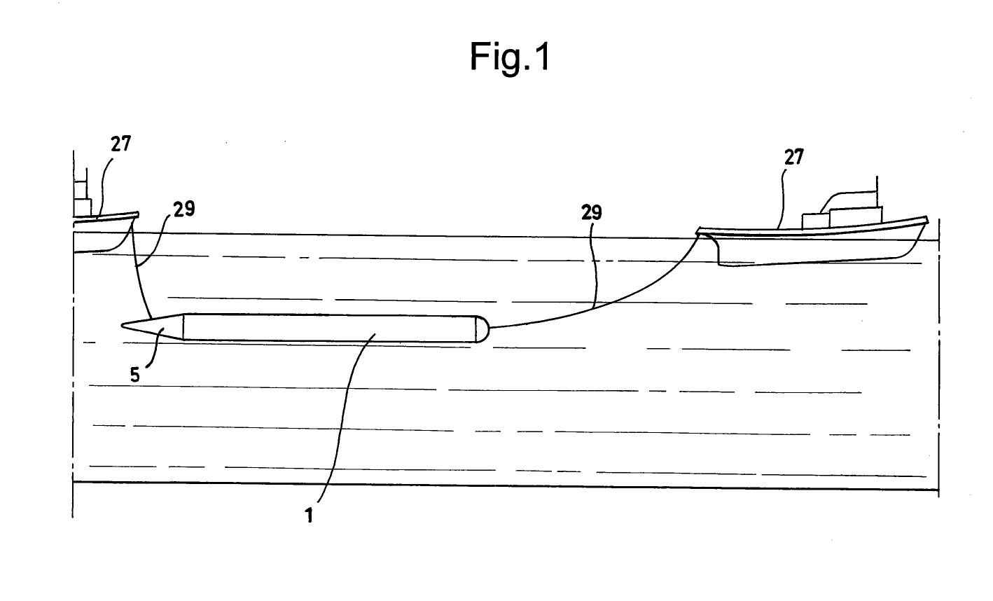

FIGS. 1 to 7 relate to an underwater vehicle for transporting fluids such as, for example, natural gas, oil or water, and a transporting system which adopts this, according to a particular embodiment of the present invention. The underwater vehicle, indicated with the overall reference number 1, is particularly suitable for exploiting wells from which prevalently gas is extracted, and together with this, a possible marginal fraction of oil and/or water. The vehicle 1 as a whole has an elongated form, advantageously like a torpedo.

The underwater vehicle 1 preferably has a streamlined tip 3, i.e. for example, a hemispherical, ogival, ovoid, conical or in any case tapered cap, and a drop-shaped or in any case tapered tail 5, so as to reduce fluid-dynamic resistances to underwater advancement; it can have sides 7 having transversal sections with a substantially constant form and dimensions; the sides 7 can therefore be substantially cylindrical or prismatic.

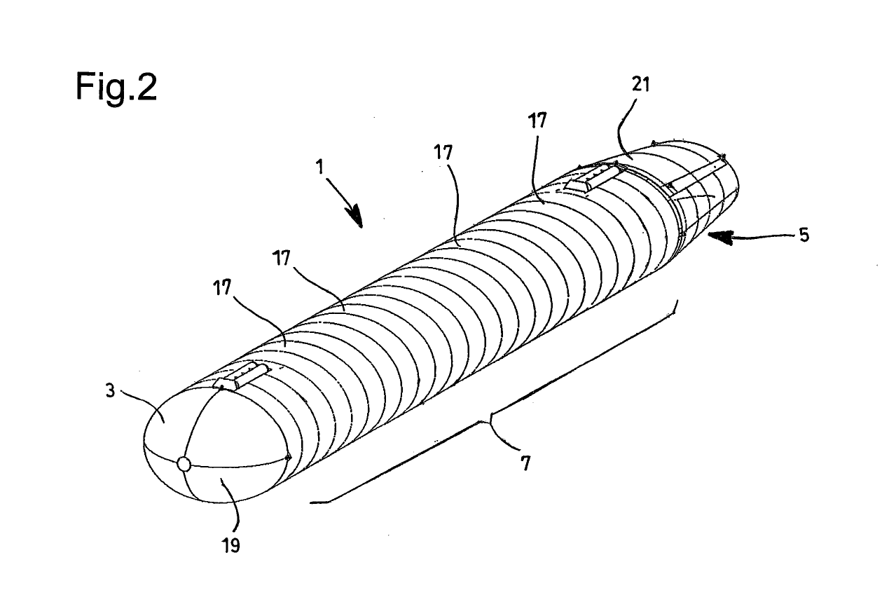

The transversal sections of the vehicle 1, or at least of its sides, have an external perimeter with a substantially elliptical form (FIGS. 2, 5, 6); the ratio between the minor and major semi-axes of said ellipsoidal perimeter preferably ranges from 0.85 to 0.5, and more preferably from 0.7-0.8; these ratios between the semi-axes have proved to be optimum for conferring a good hydrostatic stability both when immersed and during the floating of the vehicle 1.

The underwater vehicle 1 comprises one or more containment tubes 9 designed for containing the natural gas, oil, water or other fluid to be transported; according to an aspect of the invention, the one or more containment tubes 9 form a bundle which prevalently extends longitudinally with respect to the underwater vehicle 1.

The one or more containment tubes 9 advantageously form a substantially straight bundle, i.e. with a substantially straight axis.

The vehicle 1 preferably also comprises a main structure 11 designed to withstand loads, for example by bending or compression, the vehicle 1 itself and comprising a plurality of structural tubes 13 which substantially extend longitudinally with respect to the underwater vehicle 1.

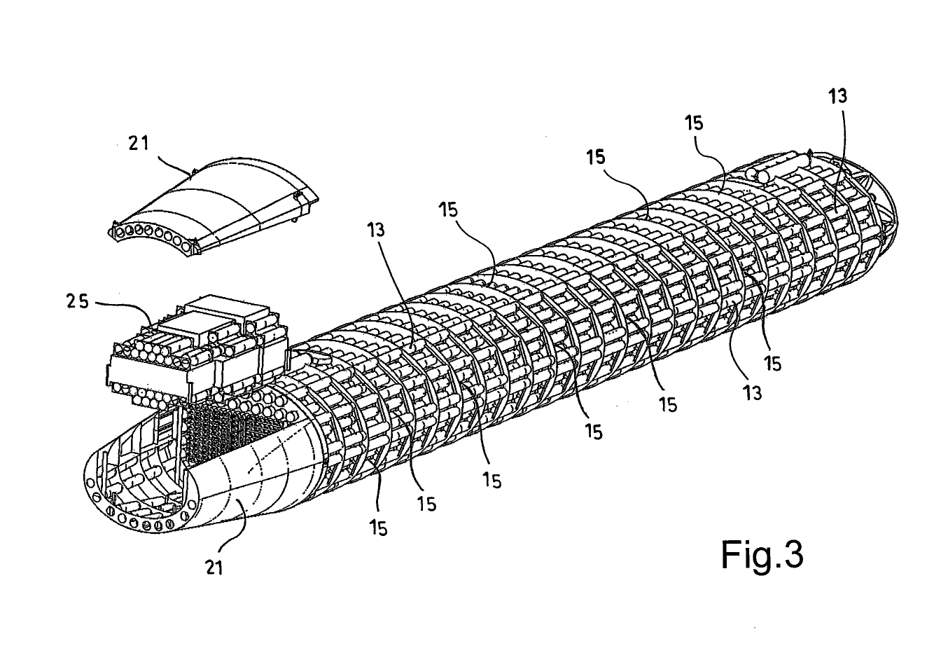

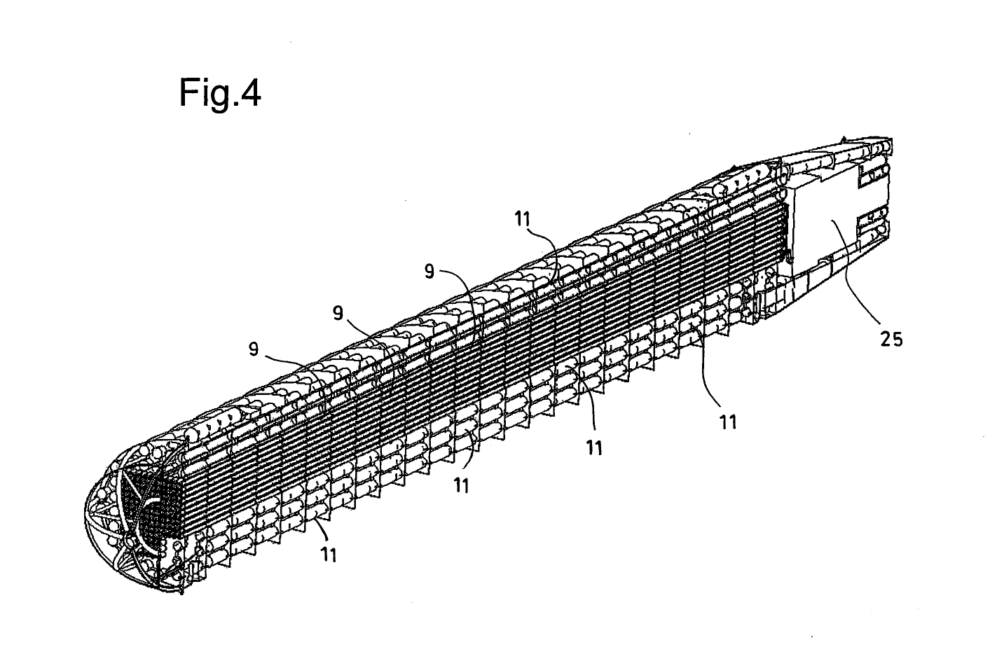

As in the embodiment illustrated, the containment tubes 9 and/or the structural tubes 13 preferably extend for at least half of the overall length L of the underwater vehicle 1, more preferably for at least three-quarters of the length L (FIGS. 3, 4).

The main structure 11 preferably also comprises a plurality of transverse frames 15 positioned substantially transversal to the containment tubes 9 and structural tubes 13, supporting them and holding them in precise positions in the space.

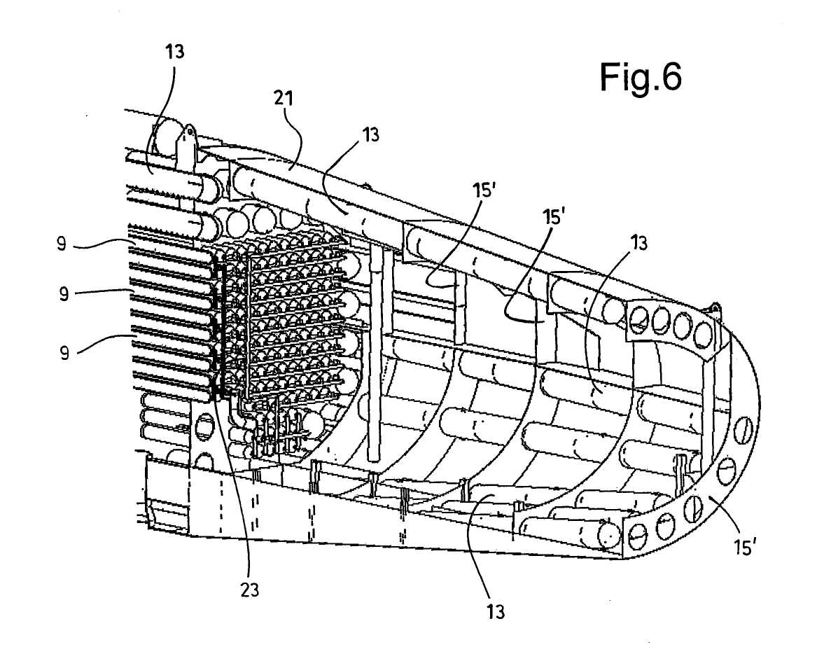

Each transverse frame 15 can comprise, for example, a main plate 150 in which there is a plurality of first holes 152 and second holes 154. Structural tubes 13 pass through the first holes 152, and containment tubes 9 pass through the second holes 154. The references 15′ of FIG. 6 indicate the transverse frames of the tail 5.

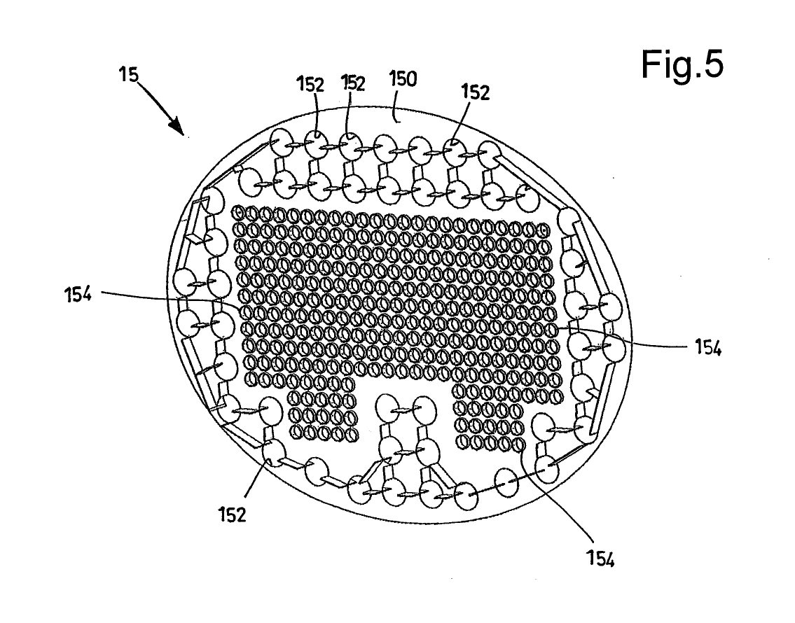

As shown in FIGS. 4, 5, at least part of the structural tubes 13 extends around the containment tubes 9, protecting them and separating them from the outside of the vehicle 1. The assembly of structural tubes more preferably extends around the assembly of containment tubes 9, surrounding and protecting the latter.

The containment tubes 9 are advantageously fixed, in a longitudinal direction, substantially in correspondence with a single transverse frame 15—or another transversal section—of the main structure 11, whereas they are free to slide longitudinally with respect to the other transverse frames, thus being free to compensate the variations in length due to the variations in temperature and pressure of the fluid to be transported contained therein. In this way, the containment tubes 9 do not exert structural functions and are only subjected to stress by the difference between their internal and external pressures. The structural tubes 13, on the other hand, can be fixed—for example welded—to all the transverse frames 15.

The containment tubes 9 can be advantageously obtained from ordinary tubes for underwater pipelines, in conformance for example with the standards API SPEC 5L, ISO3183 or DNV OS-F101. The containment tubes 9 can be designed, for example, to withstand an internal pressure of 250 bar and an external pressure of 45 bar; in this case, the maximum operational depth of the vehicle 1 would be about 450 metres; the containment tubes 9 can, for example, have a nominal internal diameter within the range of 20-52 inches, and equal, for example, to about 36 inches. The functioning depth of 450 metres is optimum as the external water pressure is substantially counterbalanced in this respect by the pressure (preferably 45 bar) of the content of the tubes 9. Both the containment tubes 9 and the structural tubes 13 can, for example, be made of steel, another suitable metallic material, carbon fibres, fibreglass or another composite material.

Advantageously at least part, and preferably all, of the structural tubes 13 is designed for being reversibly filled and emptied with a suitable ballast material, such as for example, the same water in which the underwater vehicle 1 is immersed, so as to control and vary the floating or immersion depth of the underwater vehicle 1.

In order to reduce the fluid-dynamic resistance, the main structure 11 is covered by a covering shell composed, for example, of a plurality of panels 17, 19, 21, made of fibreglass, another suitable synthetic resin or metal sheet. The covering shell gives the underwater vehicle 1 a more hydrodynamic and smooth shape (FIG. 2). In order to simplify the construction, the covering shell is not watertight, so that the same pressure present outside of it, can also be present naturally in its interior.

The various containment tubes 9 are preferably hydraulically connected with each other by means of one or more collectors 23 (FIG. 6) and can be isolated from each other by means of suitable valves, so as to allow the various tubes 9 to be emptied or filled, either altogether or selectively.

The underwater vehicle 1 is advantageously provided with one or more of the following plants:

a) a mechanical, electrical and/or chemical separation plant, for separating the possible solid or liquid phase from the gas with which the containment tubes 9 are filled;
b) a plant for stabilizing the stored oil and separating its more volatile fractions and possible gases dissolved therein;
c) a plant for separating the acid gases;
d) a plant for separating predetermined phases or substances from the gas or other fluid to be transported; these removal phases can comprise, for example, salts, sand or water;
e) a plant for re-injecting fluids—such as, for example, gas and/or liquids into geological formations;
f) a plant for compressing the gases to be stored in the containment tubes 9 and/or air for feeding a circuit of compressed air destined for activating several motors and devices onboard;
g) emergency plants;
h) plants for telemetry, localization and control of the vehicle 1 and its containers;

i) a plant for the generation of power for possibly feeding other plants present on the vehicle.

The separation plant of acid gases can separate, for example, CO₂ or hydrogen sulphide by cycles with amines, resorting, for example, to membrane separators, cryogenic cycles, PSA (Pressure Swing Adsorber) membranes, molecular sieves and/or possibly effecting operations such as, for example, adsorbing and separating the sweetened gas, purifying the amine(s), separating the elemental sulfur, re-injecting the CO₂, hydrogen sulphide or other acid gases into the reservoir.

The elemental sulfur, or other undesired impurities and substances separated from the gas or oil, can be advantageously preserved and transported on the same vehicle 1 to be disposed of or resold at destination.

Advantageously the plants a)-i) possibly present, or at least their motors, pumps and electric, electronic and hydraulic circuits for communication and power transmission are all grouped in a removable module 25 designed for being rapidly and easily removed from the rest of the vehicle 1 and re-inserted therein (FIG. 3). The hydraulic or electric circuits onboard the removable module 25 are preferably provided with couplings or other rapid connection systems to the parts of the hydraulic and electric circuits or mechanical systems that remain permanently fixed on the rest of the vehicle. These couplings can, for example, be of the screw, bayonet or snap type. In this way, the mechanically or electrically more complex components and those subject to breakdowns and wear of the vehicle 1, can be rapidly removed to be subjected to programmed servicing and maintenance in specific workshops, whereas the rest of the vehicle 1 waits in a port or dock, or is even better equipped with another removable module already serviced, and can continue to operate.

The hydraulic, electrical, chemical plants and various motors, pumps and drives onboard the vehicle 1, can be supplied with energy coming for example from the vessels 27 that tow or in any case guide the vehicle 1 itself. The electric or mechanical power supplied by the vessels 27 can be stored by the vehicle 1, for example by accumulating compressed air in suitable tanks onboard and/or in suitable electric accumulators. The vessels 27 preferably supply the vehicle 1, and more specifically its removable module 25, only when the latter is not in navigation and when it is anchored, for example, and connected to the wellhead from which it loads the fluid to be transported.

The underwater vehicle 1 can have an overall length L of several hundreds of metres, ranging, for example, from 250-350 metres or from 100-400 metres, and have, for example, elliptical transversal sections with a major semi-axis ranging from 35-45 metres and a minor semi-axis ranging from 25-35 metres. With these dimensions, the vehicle 1 can have a loading capacity of about 12 MSCM (millions of standard cubic metres), i.e. equivalent to that of CNG-Compressed Natural Gas-ships currently being designed.

The underwater vehicle 1 can be used, for example, as a shuttle for removing crude oil and/or natural gas directly from underwater wells and transporting it to a receiving station on the mainland, such as for example, a terminal of a gas pipeline, oil-pipeline or refinery. The separation plants of acid gases and more volatile fractions allow natural gas or oil to be loaded directly from the extraction well, with the offloading of products already pretreated at destination.

The vehicle 1 can be without its own propulsion engines and be designed for being towed by one or more tugs 27—preferably offshore tugboats—, icebreakers, or other vessels, for example by means of chains or hawsers 29. During towing, the vehicle 1 is preferably also guided by a second tugboat—or other vessel—27 by means of a chain or hawser 29 fixed in correspondence with or close to the stern 5 of the vehicle 1. The vehicle 1 can load the crude oil and/or natural gas to be transported directly from a submerged wellhead, for example through a disconnectable turret—for example of the APL (Advanced Production Loading) type—situated close to the seabed or at an intermediate depth, for example if the seabed is lower than the maximum operational depth of the vehicle 1.

During the loading operations, the vehicle 1 can rest on suitable bases, in turn resting on the seabed, remain hanging on the supporting buoy 31 described in more detail hereunder or be anchored to suitable tensioned turrets or fixed buoys and in turn anchored onto the seabed.

Resorting to fixed buoys is useful, for example, if the crude oil, natural gas or other fluid to be transported comes from a seabed situated at a greater depth than the maximum operational depth of the vehicle 1 itself.

The vehicle 1 can be anchored to the bases by means of cables or chains. The fixing and releasing operations of the anchoring chains or cables, of the APL turret, sleeves or other pipelines for loading the fluid to be transported onto the vehicle 1 or unloading it therefrom can be effected, for example, by means of suitable ROVs. During navigation, the vehicle 1 is preferably towed, remaining completely submerged at such depths as to reduce risks of collision with vessels and other floating objects, for example at depths ranging from 20-100 metres, more preferably ranging from 40-80 metres, for example from 50 to 70 metres. Navigation in immersion at significant depths also reduces the drag due to waves and wind. Furthermore, towing the completely immersed vehicle 1 provides greater isolation for the crew from flammable or explosive loads and generally increases the intrinsic safety of the transportation.

During navigation at full load, the weather/sea conditions may become particularly prohibitive, making it necessary to abandon the system.

For reasons of safety, two abandonment procedures can be adopted, for example, without the risk that the vehicle 1, going adrift, can reach the coast, with the risk of spills:

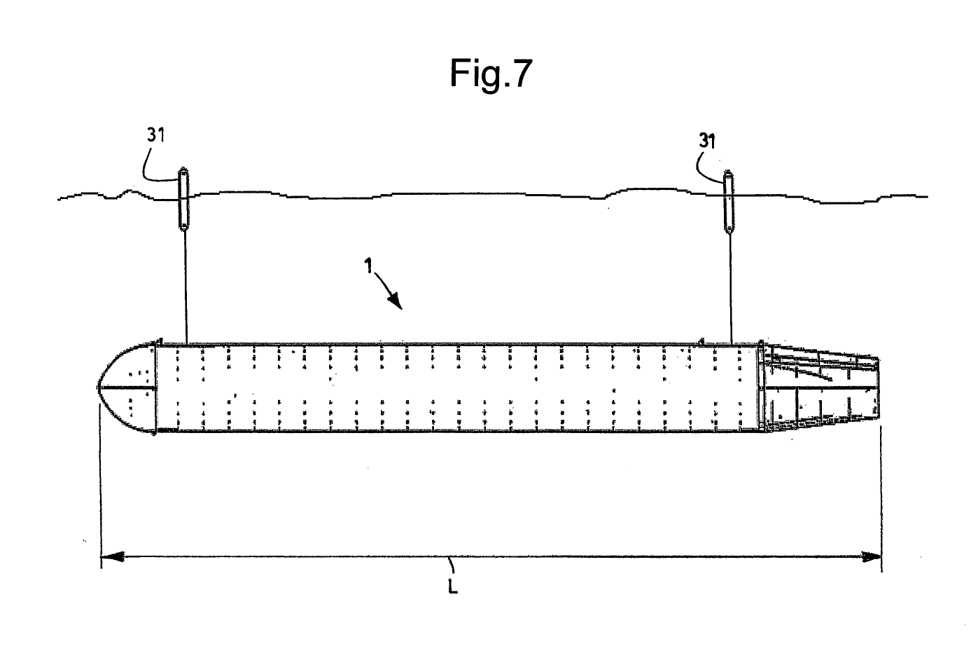

A1) detaching the underwater vehicle 1 from the towing vessels and letting it rest on the seabed;
A2) suspending it to the supporting buoys 31 (FIG. 7).

If, after effecting the procedure A1), the vehicle 1 rests on seabed at a depth greater than 500 metres, the times for recovering it may be extremely lengthy and, in order to reduce them, the vehicle 1 can be advantageously equipped with suitable signallers such as, for example, pingers, or other acoustic signalling devices.

In order to execute the emergency procedure A2), the vehicle 1 can carry the buoys 31 onboard; under normal conditions, the buoys 31 can be ballasted, for example, with water which, in an emergency situation, can be expelled allowing the buoys to rise towards the surface. In an emergency situation, the vehicle 1 preferably remains suspended to the buoys 31 at a significant depth equal or comparable to those of normal navigation, for example 50-80 metres, so as to avoid accidental impact with vessels or other floating objects, well away from the coast and without ever coming into contact with the atmospheric air. The buoys 31 on the surface guarantee visibility to other vessels and allow the vehicle 1 to be localized for subsequent recovery, as they are preferably equipped with signalling devices such as for example, stroboscopic lights, GPS antennas and a satellite communication system, for example of the Iridium or equivalent type, capable of sending the position of the vehicle 1 to an operating centre, pingers, sonars or other acoustic signalling devices.

The fact of being able to use ordinary tubes for underwater pipelines, for producing the containment tubes 9, in particular straight, allows a transportation vehicle to be constructed with relatively very low costs, as semi-processed products can be exploited, such as tubes for pipelines, which are widely available on the market, relatively economical, extremely reliable and tested, and produced in large quantities according to qualitative standards which are generally considerably high. The storage of the fluid to be transported in a tube bundle, such as that of the tubes 9, allows the load to be split into several containers, significantly limiting damage deriving from possible fires, explosions and spills in the case of faults or breakages.

Furthermore, the load can be distributed with considerable freedom and precision so as to optimize the stability of the vehicle. The load bearing frame 11 has an extremely sturdy structure and can also be produced at low costs with simple technologies, being mainly composed of metallic tubes, mostly straight, and transverse frames that can be obtained from flat metal plates or in any case only slightly bent, or from standard semi-processed products which are quite common and can be easily assembled by means of welding. The fact of also using the structural tubes 13 as ballast tanks for regulating the immersion or floating of the vehicle 1 contributes to reducing the costs and construction complexity of the latter. Its hollow tube-bundle structure makes the load bearing frame 11 extremely robust. The underwater vehicle 1 is very suitable for being used as a shuttle for transporting crude oil or natural gas from underwater extraction fields to the closest fixed refining or transportation plants on the mainland, especially, but not only, for exploiting wells with a relatively low extraction capacity or extremely deep wells with wellheads situated, for example, at 2000-3000 metres in depth: in both cases, the connection, with the laying of oil-pipelines or gas-pipelines and other fixed infrastructures, could be only slightly or not at all economically convenient.

The embodiment examples previously described can undergo various modifications and variations, all included in the protection scope of the present invention. Furthermore, all the details can be substituted by technically equivalent elements. The materials used, for example, as also the dimensions, can vary according to technical requirements. It should be understood that an expression of the type “A comprises B, C, D” or “A is composed of B, C, D” also comprises and describes the particular case in which “A consists of B, C, D”. The examples and lists of possible variants of the present patent application should be considered as being non-exhaustive lists.

1-13. (canceled)

14. An underwater vehicle for transportation of extraction fluids, wherein the device has an overall elongated form and comprises:
one or more containment tubes configured to contain the fluid to be transported and forming a bundle that prevalently extends longitudinally with respect to the underwater vehicle.

15. The underwater vehicle according to claim 14, comprising one or more of the following plants:
a) a separation plant for separating possible solid or liquid phase from the gas with which the containment tubes are filled;
b) a plant for stabilizing stored oil and separating its more volatile fractions and gases or other undesired components dissolved therein;
c) a plant for separating acid gases;
d) a plant for separating predetermined phases or substances from the fluid to be transported;
e) a plant for re-injecting the fluids into geological formations;
f) a plant for compressing gases to be stored in the containment tubes and/or air for feeding a circuit of compressed air destined for activating a series of motors, actuations, and devices onboard;
g) an emergency system;
h) a plant for signalling, telemetry, localization or control of the vehicle, or at least its containment tubes;
i) a plant for generation of power for possibly feeding other plants present on the vehicle.

16. The underwater vehicle according to claim 15, further comprising a removable module including at least part of motors, pumps, hydraulic, electric or electronic circuits for power transmission or communication of one or more of the plants a)-i),
wherein the removable module is configured to be reversibly removed from and reinstalled on the vehicle.

17. The underwater vehicle according to claim 14, further comprising a main structure frame configured to structurally strengthen the vehicle itself and comprising a plurality of structural tubes that prevalently extend longitudinally with respect to the underwater vehicle.

18. The underwater vehicle according to claim 17, wherein at least part of the structural tubes is configured to be reversibly filled and emptied with a ballast material, to control and regulate floating or submersion depth of the underwater vehicle.

19. The underwater vehicle according to claim 17, wherein at least part of the structural tubes extends around the bundle of containment tubes, or enclosing the bundle.

20. The underwater vehicle according to claim 17, comprising one or more frames positioned substantially transversal to the bundle of containment tubes and/or structural tubes, fixing or keeping the containment tubes and/or structural tubes in specific positions.

21. The underwater vehicle according to claim 17, wherein each containment tube is fixed axially to the main structure frame substantially in correspondence with only one frame or only one transversal section of the vehicle, eliminating or reducing flexural and/or axial stress applied by the main structure frame to the containment tubes.

22. The underwater vehicle according to claim 14, whose sides form at least a sector having transversal sections in turn having an outer shape with a form selected from the following: substantially elliptical, substantially ovoid, substantially oblong.

23. The underwater vehicle according to claim 17, further comprising a covering shell that covers the main structure and containment tubes giving them a more hydrodynamic and smooth outer shape, wherein the covering shell is not watertight so that the liquid in which the vehicle is immersed penetrates the shell, substantially compensating hydrostatic pressures in force outside and inside the shell itself.

24. A process for using an underwater vehicle according to claim 14, comprising an operation of towing the submerged vehicle by a ship or other craft.

25. The process according to claim 24, comprising:
disconnecting the underwater vehicle from the ship or other craft towing the underwater vehicle;
suspending the vehicle to one or more floating buoys.

26. A process for using an underwater vehicle according to claim 14, comprising:
hydraulically connecting the underwater vehicle to a head of an extraction well for fluid extraction;
transferring and storing on the vehicle, the fluid extracted from the well, subjecting the fluid extracted to one or more of following processes through plants installed onboard the vehicle itself;
mechanical, electrical or chemical separation;
separation of gases or more volatile fractions of the extracted fluid;
extraction and elimination of acid gases, carbon dioxide, or hydrogen sulphide;
compression;
liquefaction;
re-injection into geological formations.
